(19) United States
(12) Patent Application Publication
(10) Pub. No.: US 2022/0256213 A1
(43) Pub. Date: Aug. 11, 2022

(54) SYSTEMS, METHODS, AND DEVICES FOR NETWORK CONTROL

(71) Applicant: Comcast Cable Communications, LLC, Philadelphia, PA (US)

(72) Inventors: James Panagos, Denver, CO (US); Jeffrey Elsloo, Centennial, CO (US); Dylan Souza, Denver, CO (US); Chris David Lemmons, Denver, CO (US); Evan Zelkowitz, Denver, CO (US); Brian Olsen, Centennial, CO (US)

(21) Appl. No.: 17/248,826

(22) Filed: Feb. 9, 2021

(51) Int. Cl. H04N 21/2343; H04N 21/239; H04N 21/2662; H04N 21/845

(52) U.S. Cl. CPC H04N 21/23439; H04N 21/8456; H04N 21/2662; H04N 21/2393

(57) ABSTRACT

Systems, methods, and devices relating to network control are described herein. In a method, a computing device may receive a request from a client device for a first segment of a first version of a content asset. The computing device may determine, based on one or more usage characteristics associated with a capability of the computing device to provide content to connected client devices, a second version of the content asset for the client device to request in one or more subsequent requests for the content asset. The computing device may send the requested-for first segment to the client device via a response that also comprises a header, trailer, or metadata indicating the second version of the content asset. The computing device may receive a second request for a second segment of the second version of the content asset.

### BACKGROUND

There exist numerous challenges in managing network control, including that relating to application-layer network messages. While there may be traffic control mechanisms at one or more of the lower network levels (e.g., the transport layer, such as TCP), this may prove insufficient in handling conditions in which a server connection is application limited. For example, if a server is overloaded (e.g., at the application level)—and despite there being sufficient network capacity between a client device and the server—the client device may continue to make repeated data requests to the server. Indeed, the repeated requests from the client device and others may only exacerbate the server overload condition.

These and other shortcomings are addressed in the present disclosure.

### SUMMARY

Systems, methods, and devices relating to network control are described herein. For example, such control techniques may be implemented at a server to regulate the bitrates of video streams that the server provides to requesting client devices.

A server (e.g., a computing device) may receive, from a client device (e.g., a computing device), a first request (e.g., an HTTP request) for a first segment of a first version of a content asset (e.g., a television program or movie). The first version may be associated with a first bitrate and/or a first encoding algorithm. Based on one or more usage characteristics associated with a capability of the server to provide content to client devices connected to the server (e.g., a server load or hardware/software configuration), the server may determine a second version of the content asset, associated with a second bitrate and/or a second encoding algorithm, for the client device to request in one or more subsequent segments requests to the server. For example, if there are too many client devices connected to the server or too many requests are being sent to the server, the server may determine a second version that is associated with a lower bitrate than that associated with the first version of the content asset. The server may send the requested-for first segment to the client device via a response that indicates the second version of the content asset. The response may indicate the second version of the content asset via a header, trailer, or metadata. The server may receive, from the client device, a second request for a second segment of the second version of the content asset. The server may send the second segment to the client device via a second response, which may indicate (e.g., via header, trailer, or metadata) the second version of the content asset again or a different version of the content asset determined by the server based on one or more usage characteristics associated with a capability of the server to provide content to client devices connected to the server (e.g., the server's current load). This process may continue over multiple iterations until the client device breaks connection with the server or stops requesting segments of the content asset from the server.

A server (e.g., a computing device), may receive, from a client device (e.g., a computing device), a request for a first segment of a first version, of a plurality of versions, of a content asset. The first version of the content asset may be associated with a first bitrate and/or a first encoding algorithm. Based on one or more usage characteristics associated with a capability of the server to provide content to client devices connected to the server, the server may determine a second version, of the plurality of versions, of the content asset. The second version of the content asset may be associated with a second bitrate and/or a second encoding algorithm. The server may send a response to the client device comprising a second segment of the second version of the content asset for viewer consumption at the client device. The response may indicate the second version of the content asset, such as via a header, trailer, or metadata associated with the response. The response may comprise an instruction for the client device to request subsequent segments of the second version of the content asset. The server may receive, from the client device, a request for a third segment of the second version of the content asset.

A server (e.g., a computing device) may determine, based on one or more usage characteristics associated with a capability of the server to provide data to client devices connected to the server, a request rate associated with a client device (e.g., a computing device) for the client device to use in sending one or more subsequent data requests to the server. A request rate may refer to the rate at which the client device sends data requests to the server (e.g., 30 requests per minute). The server may determine the request rate based on (e.g., responsive to or subsequent to) an earlier data request sent, according to an earlier request rate, to the server from the client device. The data object indicated in the earlier request may comprise a segment of a first version of a content asset, for example. The server may send the determined request rate to the client device via a response indicating (e.g., via a header, trailer, or metadata) the request rate. The client device may determine a second version (with an associated bitrate) of the content asset to request based on the request rate determined by the server. The server may receive, according to the request rate, a request for another data object from the client device. The data object may comprise a segment of the second version of the content asset. The server may send the data object to the client server via a second response. The second response may indicate (e.g., via header, trailer, or metadata) a different, second request rate or again the request rate previously determined. This process may also be continued over multiple iterations, as needed.

A response from a server may additionally or alternatively indicate an anticipated shutdown of the server and an anticipated time of shutdown (e.g., via header, trailer, or metadata). The time of the shutdown may be indicated in the form of a countdown value (e.g., in seconds). The client device may elect to stay connected to the server until or almost until the server is shutdown. Such a response may additionally or alternatively indicate an alternate server from which the client device may continue to receive segments of a content asset once the initial server shuts down.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF DRAWINGS

The accompanying drawings, which are incorporated in and constitute a part of this specification, illustrate embodiments and together with the description, serve to explain the principles of the systems, methods, and devices:

FIG. 1 shows an example system.

FIG. 2 shows an example method.

FIG. 3 shows an example network message flow.

FIG. 4 shows an example method.

FIG. 5 shows an example method.

FIG. 6 shows an example network message flow.

FIG. 7 shows an example network message flow.

FIG. 8 shows an example network message flow.

FIG. 9 shows an example computing device.

Aspects of the disclosure will now be described in detail with reference to the drawings, wherein like reference numbers refer to like elements throughout, unless specified otherwise.

### DETAILED DESCRIPTION

Systems, methods, and devices relating to network control are described, including video stream bitrate and request rate control techniques. Such control techniques may be applied, for example, to regulate the bitrates of the content asset video streams that a server provides to various requesting client devices. This may prevent the server from being overloaded by an excessive number of requests from client devices. For example, during an HTTP/1.0 or HTTP/1.1 server-client connection, TCP (Transmission Control Protocol) may implement traffic control algorithms to address situations where the connection is network (e.g., Congestion Window (CWND)) or receiver (e.g., Receiver Window (RWND)) limited. However, when the connection is application limited (e.g., there isn't enough downstream data for the network or receiver to be the limiting factors), there is nothing performing traffic control, despite the need. Most clients simply “give-up-and-retry” when failures occur, but re-requesting from an already-overloaded server is generally not going to result in any improvements to the problem. Since clients will often continue making requests until otherwise directed, it may be difficult for an overloaded server to recover. In some cases, clients will even increase their request rate when a failure is encountered.

In addition, content delivery network (CDN) client routing technologies often take a binary view of a system's availability. A system is either healthy and can field requests or it is not healthy and cannot field requests. This can lead to cascading failures as an overloaded, but otherwise healthy system can be taken out of service, forcing all of its (new or existing) traffic to other systems, causing the same problems there, and so on. Also, in some cases, a server will try to field as many requests as possible and as quickly as possible. This is not always ideal as it artificially reduces the number of concurrent requests that can be serviced, by transferring data faster than the clients actually need it. HTTP/2.0 (and HTTP/3) may offer limited flow-control functionality as a consequence of multiplexing streams over a TCP connection. However, many of the aforementioned difficulties will still persist because any such flow control is from the client's perspective.

Yet, as described fully herein, a server may determine, for example, that a client device should downshift to a version of a streaming content asset with a lower bitrate. The server may communicate the downshifted version of the content asset to the client device in a header of a response message (e.g., an HTTP response) from the server, which may include a segment of a requested-for version of the content asset. In a subsequent request to the server, the client device may request a segment of the downshifted version of the content asset, as instructed by the server. Additionally or alternatively, the server may send a segment of the downshifted version of the content asset in the server's first response, rather than waiting for the client device to start requesting segments of the downshifted version. Although it may often be described herein that information is communicated from a server to a client device via a response header, such information may be additionally or alternatively conveyed via a trailer or metadata associated with the response.

The network control techniques described herein may be additionally or alternatively applied to regulate the rate at which connected client devices send requests to a server. Such requests may be for a video stream of a content asset or other type of data. For example, based on a server's load or other usage characteristic associated with the server at the time, the server may determine, for a particular client device, an adjusted request rate that the client device is to adhere to in sending one or more subsequent requests to the server. The server may communicate this request rate to the client device via a response (e.g., an HTTP response) with a header that indicates the adjusted request rate. This response may comprise a segment of a video stream or other type of data requested by the client device.

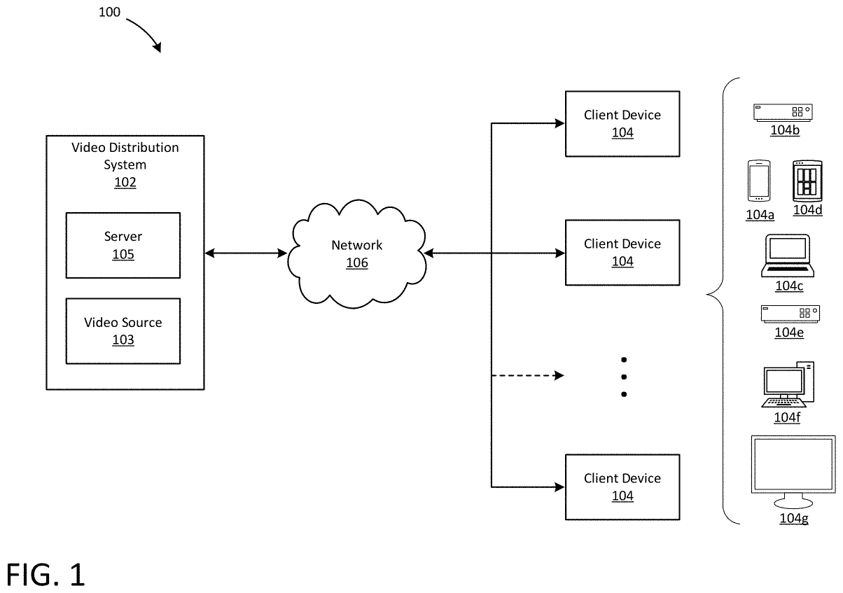

FIG. 1 illustrates a block diagram of a system 100 in which the present systems, methods, and devices may be implemented. The system 100 comprises a video distribution system 102 and one or more client devices 104 configured to receive video content from the video distribution system 102. The client devices 104 may receive the video content via a server 105 (e.g., an HTTP server) of the video distribution system 102 and a network 106.

A client device 104 may comprise any one of numerous types of devices configured to effectuate video playback and/or viewing. A client device 104 may comprise a display device, such as a television display 104g. A client device 104 may comprise a computing device, such as a laptop computer 104c or a desktop computer 104f A client device 104 may comprise a mobile device, such as a smart phone 104a or a tablet computer 104d. A client device 104 may be configured to receive video content and output the video content to a separate display device for consumer viewing. For example, a client device 104 may comprise a set-top box 104e, such as a cable set-top box. A set-top box 104e may receive video content via a cable input (e.g., co-axial cable or fiber optic cable) and format the received video content for output to a display device. A set-top box 104e may receive video content via digital video streaming. A set-top box 104e (or other type of client device 104) may comprise a quadrature amplitude modulation (QAM) tuner. A set-top box 104e may comprise a digital media player or a gaming device.

A client device 104 may comprise a digital video recorder (DVR) 104b that receives and stores video content for later viewing. Other client devices 104 may also implement features that allow received video content to be stored on the device for later viewing. A client device 104 may be in communication with a cloud DVR system to receive video content. A client device 104 may combine any features or characteristics of the foregoing examples. For instance, a client device 104 may include a cable set-top box with integrated DVR features. A client device 104 is not strictly limited to a video playback device, but may include a computing device more generally, regardless of whether it is capable of playing video.

A client device 104 may be configured to process (e.g., understand or interpret) and honor or adhere to the various types of headers described herein that may be included in a response from the server 105. For example, a client device 104 may be configured to process a header indicating an adjusted bitrate for a video stream being provided to the client device 104 and subsequently request that video stream from the server 105 at the adjusted bitrate. As another example, a client device 104 may be configured to process a header indicating an adjusted request rate for the client device 104 and adhere to that adjusted request rate in making one or more subsequent requests to the server 105.

A client device 104 may refer to a software “client” in addition to or instead of a hardware device. In this sense, for example, a client device 104 may comprise a web browser, a media streaming application (e.g., installed on a mobile device), or the software installed in a set-top box. For example, a media streaming application may generate a request for a video object, receive the subsequent response with the video object, and decode the video object for viewing.

The video distribution system 102 may generally effectuate video content delivery to the client devices 104. The video distribution system 102 may comprise a cable or satellite television provider system. A cable or satellite television provider system may deliver video content according to scheduled broadcast times and/or may implement video-on-demand services. The video distribution system 102 may comprise a digital video streaming system. The video distribution system 102 may implement a cloud-based DVR system configured to deliver “recorded” video content upon request from a client device 104. The video distribution system 102 may comprise, at least in part, a content delivery network (CDN). Some portions of the video distribution system 102 may comprise part of a CDN and other portions of the video distribution system 102 may be external to the CDN.

The video distribution system 102 may comprise the video source 103. The video source 103 may store and/or provide video content that is ultimately delivered to the client devices 104. The video source 103 may comprise stored video content, such as that anticipated to be delivered as digital streaming video, on-demand video, or cloud DVR recorded video. The video source 103 may comprise video content intended for immediate or near-immediate broadcast, such as a live television video feed. For example, the video source 103 may comprise video content that has not yet been broadcast or made available for digital video streaming or on-demand video delivery. The video source 103 may comprise backhaul video content.

The video distribution system 102 may comprise one or more servers 105 (e.g., computing device(s)) generally configured to receive, from a client device 104, a request for a data object (e.g., a video segment) and return a response comprising that data object (or a portion thereof) to the client device 104. The response may further comprise a flow-control header configured to direct the client device 104 in one or more aspects relating to the client device's 104 subsequent requests to the server 105 (e.g., request pacing, video bitrate, etc.). The server 105 may be configured for HTTP data communications, but may be additionally or alternatively configured to communicate with the client devices 104 via other request-response application layer (e.g., layer 7) protocols. The control techniques described herein are equally application to these other protocols in addition to HTTP.

In a CDN implementation, the server 105 may comprise an edge server of the CDN. The CDN may have numerous servers 105 to service a wide base of users (e.g., client devices 104). The video source 103 may comprise an origin server or an intermediate cache between an origin server and the server 105.

The network 106 may comprise a private portion. The network 106 may comprise a public portion, such as the Internet. The network 106 may comprise a content distribution and/or access network. The network 106 may comprise a cable television network or a content delivery network. The network 106 may facilitate communication via one or more communication protocols. The network 106 may comprise fiber, cable, or a combination thereof. The network 106 may comprise wired links, wireless links, a combination thereof, and/or the like. The network 106 may comprise routers, switches, nodes, gateways, servers, modems, and/or the like.

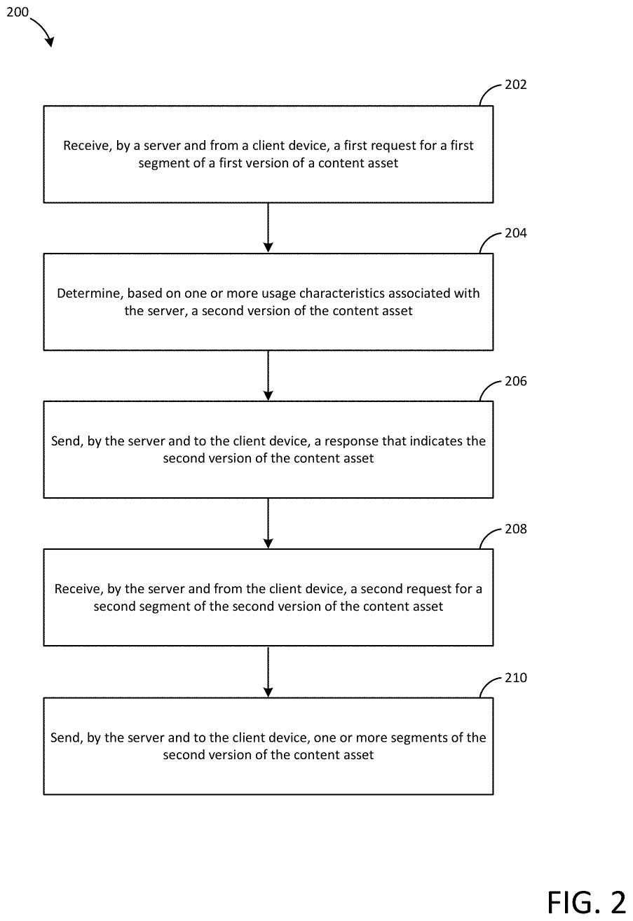

FIG. 2 shows a method 200. The method 200 may relate to video stream bitrate control, such as via control headers. Such video streams may be configured for adaptive switching between various versions or representations of a content asset, i.e., adaptive bitrate streaming. Example implementations of adaptive bitrate streaming may include MPEG-DASH (Dynamic Streaming over HTTP), Adobe HTTP Dynamic Streaming (HDS), Apple HTTP Live Streaming (HLS), or Microsoft Smooth Streaming.

A content asset may comprise one or more of linear content, non-linear content, video content, audio content, multi-media content, a movie, a television show, a presentation, a song, an album, a live broadcast, recorded content, stored content, or any other form of content a user may wish to consume. A content asset may comprise one or more versions of the content asset, each of which may be referred to as a stream. A version of a content asset may be additionally or alternatively referred to as a representation of the content asset or a video stream profile. Each version may comprise a different encoding of the content asset. Each version may have properties that differ from other versions, such as a different encoding bitrate, compression technique, compression ratio, resolution, frame rate, video quality (for video), number of channels, or sampling rate (for audio). Each version of a content asset may comprise a plurality of portions. Each portion may comprise one or more segments, sometimes also referred to as chunks or fragments, which may be independently accessible for playback on a user device.

At step 202, a server (e.g., the server 105 of FIG. 1) may receive a first request (e.g., an HTTP request) from a client device (e.g., a client device 104 of FIG. 1) for a first segment of a first version, of a plurality of versions, of a content asset. The first version of the content asset may be associated with a first bitrate. Additionally or alternatively, the first version of the content asset may be associated with a first encoding algorithm. The first segment may comprise a video segment, for example. The client device may have requested the first segment of the first version based on a manifest associated with the content asset that was earlier provided to the client device by the server. The manifest may indicate any available versions (e.g., video streams) of the content asset and the segments associated with each of the available versions of the content asset.

The first bitrate may have been determined by the client device according to the client-side adaptive bitrate algorithm associated with the particular adaptive bitrate streaming technology in use. For example, the client device may determine the first bitrate based on the capabilities of the client device's hardware and/or software, a current video buffer level at the client device, the video stream throughput in recent prior downloads, and/or the available or estimated network bandwidth between the client device and the server. As the network bandwidth (or any of the other aforementioned criteria) fluctuates, the client device may upshift or downshift the bitrate of the received video stream by requesting a different version of the content asset accordingly. The bitrate associated with each available version of the content asset may be known. To switch the video stream to a specified bitrate, the client device and/or server may determine the version of the content asset associated with this bitrate and the client device may begin to request and receive segments of that version.

If the client device's hardware/software are capable of doing so and sufficient bandwidth is available, the client device may often request a version of the content asset that is associated with a high bitrate—or even the highest bitrate—since the client-side adaptive bitrate algorithm is designed to provide the highest video quality possible for the client device's user. Yet this does not take into account the state of the server or its ability to provide the video stream at the requested bitrate. For example, the server may be overloaded and unable to service all—or even any—of the high-bitrate requests from this particular client device or other client devices. The same may be true for the various encoding algorithms that may be used to encode versions of the content asset, some of which may be more or less computationally demanding than others. It is noted that the multiple encoding algorithms available to encode the versions of the content asset (if applicable) may or may not correlate to the bitrate of the resultant encoded video. For example, one encoding algorithm may be more computationally demanding (but producing higher quality encoded video) than another encoding algorithm (producing lower quality encoded video), but each may produce encoded video having the same bitrate. Licensing fees (e.g., per-use licensing fees) for encoding algorithms may also play a factor on which encoding algorithm is selected. The video stream from the server to the client device may be application limited at the server.

Where the first request comprises an HTTP request, the first request may identify the first segment of the first version via an HTTP GET method in the first request that indicates the URI (e.g., URL) of the first segment. The URI may indicate the location of the first segment at the server or in associated storage. The first request may additionally or alternatively identify the first segment via a POST method or other suitable HTTP method.

At step 204, a second version of the plurality of versions associated with the content asset may be determined based on one or more usage characteristics associated with the server. The second version may be determined by the server. The one or more usage characteristics may be associated with a capability of the server to provide (e.g., send) content (e.g., segments of a content asset(s) or data generally) to client devices connected to the server. Client devices presently sending requests to the server may be considered as being “connected” to the server for at least these purposes. For example, a client device presently sending requests to the server via a connectionless network protocol, such as UDP (User Datagram Protocol), may still be considered as being connected to the server even if such protocol is not per se connection-oriented, such as with TCP. Such capability may refer to a capability of the server to respond to requests from client devices generally. Additionally or alternatively, such capability may refer to a capability of the server to provide content to requesting client devices at the requested bitrates. A usage characteristic associated with the server (e.g., associated with a capability of the server to provide content to connected client devices) may be a load associated with the server, for example.

The second version of the content asset may be the version that the server wants the client device to use in one or more subsequent requests for the video stream of the content asset. The second version and/or second bitrate may be a maximum (e.g., capped) version or bitrate, respectively, for the client device to use in making one or more subsequent requests for the video stream. The second bitrate may be lower or higher than the first bitrate. As an example of the former, if server load is high (e.g., the server has an impaired capacity to service requests), the second bitrate may be lower than the first bitrate so that a greater number of client devices may be serviced than would be possible if the instant client device continued to request the same first version of the content asset. As an example of the latter case, if the server load is low (e.g., the server has sufficient or more than sufficient capacity to service incoming requests), the second bitrate may be higher than the first bitrate to reflect that the client device may request a version of the content asset associated with a higher bitrate without negatively impacting the server's performance (e.g., the continued capability of the server to provide content to client devices connected to the server). In this case, the second version and/or second bitrate may be considered a maximum since the client device's adaptive bitrate algorithm may nonetheless determine that requesting the second version would not be sustainable if adopted (e.g., due to network bandwidth or the capabilities of the client device) and instead continue to request the first version of the content asset. The second version and/or second bitrate may be a single-step downshift or upshift, as the case may be, of the first version and/or first bitrate, respectively.

The second version of the content asset determined by the server may be associated with (e.g., encoded by) a second encoding algorithm. For example, the second encoding algorithm may be less computationally demanding than the first encoding algorithm associated with the first version of the content asset. The server may determine to use a less computationally demanding encoding algorithm if, for example, a more computationally demanding encoding algorithm would negatively impact the capability of the server to provide content to client devices. Where the second version of the content asset is determined, at least in part, according to an encoding algorithm, this may be particularly apt in an on-demand dynamic encoding approach. As noted above, the second encoding algorithm (if applicable) may or may not result in a bitrate that is different than the first bitrate associated with the first version of the content asset.

Additionally or alternatively, the second version and the first version may refer to the same version of the content asset. For example, the server may determine that the one or more usage characteristics (e.g., load) associated with the server neither permits the client device to request a higher bitrate version of the content asset, nor requires that the client device request a lower bitrate version of the content asset. In other words, the server may determine that the client device should continue to request the same version of the content asset, at least for the time being. For example, based on a usage characteristic associated with a capability of the server to provide content to client devices (e.g., a present server load), the server may determine that continuing to provide the same version of the content asset to the client device would not impact the performance of the server to the extent that the server would be unable to service all request sent to the server by client devices. Additionally or alternatively, based on a usage characteristic associated with a capability of the server to provide content to client devices, the server may determine that sending the higher bitrate version of the content asset to the client device would negatively impact the performance of the server to the extent that the server would be unable to service all requests sent to the server by client devices.

The one or more usage characteristics associated with the server (e.g., the capability of the server to provide content to client devices connected to the server) may comprise a load associated with the server (e.g., a server load). Such a load may refer to CPU load, GPU (graphical processing unit) load, memory usage (e.g., available memory, such as available RAM), storage usage (e.g., disk active time, read/write speeds, available and/or total storage capacity), available network resources (e.g., available bandwidth), cryptographic offload hardware utilization, thermal dissipation capacity, electrical usage, financial utilization of leased or licensed hardware, etc., or any combination thereof. Server load may be based on the concurrent number of client devices connected to the server and from which the server receives requests. Server load may be based on the number of requests being received by the server and/or a rate at which such requests are received. The server load may be associated with an application on the server that enables the video stream, such as the software-level web server (e.g., Apache HTTP Server or Nginx) running on the server. Determining the second version of the content asset may comprise determining that streaming the second version is or will be application limited or, conversely, determining that the streaming the second version is not or will not be application limited.

Server load may additionally or alternatively refer to a predicted server load. For example, while a present server load may allow the server to adequately service all requests, an upward trend in server load (e.g., determined by the server) may cause the server to determine a second version of the content asset associated with a lower bitrate and/or a less computationally intense encoder. Or conversely, a downward trend in server load may cause the server to determine a second version of the content asset associated with a higher bitrate and/or with a more computationally intense encoder. In this manner, the server may head off any request bottlenecks before they actually occur.

The one or more usage characteristics associated with the server (e.g., the capability of the server to provide content to client devices connected to the server) may include the hardware and/or software configuration of the server. Such hardware/software configuration may refer to the capabilities (e.g., capacities) of the hardware and/or software making up the server. For example, a usage characteristic associated with the server may include the server's processor(s) (e.g., number of processors, processor architecture, clock speed, number of cores, or other metric), memory (e.g., memory type, capacity, speed, read/write or access speed, or other metric), storage (e.g., storage capacity, read/write speed, or other metric), or network interface(s) (e.g., number of network interfaces, type of network interface, speed, or other metric). The one or more usage characteristics associated with the server may include the application(s) that receive and service requests from client devices. The one or more usage characteristics may include an indication that a characteristic, attribute, value, etc. associated with the server load or hardware/software configuration satisfies a threshold (e.g., is greater than, equal to, or less than, as the case may be). For example, determining the second version of the content asset may comprise determining that the one or more usage characteristics satisfies a threshold. The one or more usage characteristics may include the request rate associated with a client device. For example, the one or usage characteristics may indicate that a request rate associated with a client device satisfies (e.g., is greater than, equal to, or less than, as the case may be) a threshold request rate.

The second version of the content asset may be additionally or alternatively determined based on one or more business logic rules. For example, a particular video stream (and/or content asset thereof) may be favored over other video streams and requests for that video stream may be weighted relative to requests for the other video streams. If the instant video stream requested by the client device is a favored video stream, for example, the second bitrate may be higher than the first bitrate (or the same), and vice versa. Similar business logic rules may be additionally or alternatively applied with respect to client device, subnet, user-agent, geographical location, market, past history of service interruption, or service tier. Such business logic rules may be applied in determining the second version only when there is contention for the server's resources or such business log rules may be applied in determining the second version regardless of whether there is contention.

At step 206, the server may send, to the client device, a response (e.g., in response to the first request) that indicates the determined second version of the content asset. The response may comprise a header that indicates the second version of the content asset. Additionally or alternatively, the response may comprise a trailer and/or metadata that indicates the second version of the content asset. The response may comprise an HTTP response with an HTTP flow-control header that indicates the second version of the content asset. The response may comprise the requested-for first segment of the first version of the content asset. The client device may decode the segment and cause to output (e.g., display) the decoded segment for viewer consumption as part of the video stream.

The sending the response to the client device may be based on a capability of the server to provide (e.g., send) the first version of the content asset, e.g., the capability of the server to provide the first version of the content asset to the client device in particular and/or client devices generally. For example, high CPU or memory load on the server may negatively impact the capability of the server to provide the first version of the content asset. The sending the response to the client device may be additionally or alternatively based on a capability of the server to provide the content asset, regardless of the version of the content asset.

Depending on the implementation, the second version and/or second bitrate may be considered a “preferred” or “requested” version and/or bitrate in that the client device may not necessarily be configured to always honor the second version and/or second bitrate in making subsequent requests for segments of the content asset. In other cases, the client device may be configured such that it is bound to honor the indicated second version and/or second bitrate. For example, the client device may be configured with proprietary client software for requesting and viewing streaming video, and that client software may always comply or attempt to comply with the indicated second version and/or second bitrate, or other bitrate- or flow-control instructions given by the server.

At step 208, the server may receive a second request (e.g., an HTTP request) from the client device. The second request may be determined by the client device based on the response (e.g., a header, trailer, or metadata associated with the response) from the server and the second version of the content asset indicted therein. The second request may indicate a second segment of the second version of the content asset. The second request may be additionally or alternatively based on the client-side adaptive bitrate algorithm, which may determine that the client device and network bandwidth are capable of sustaining a video stream of the second version associated with the second bitrate.

The response from the server and/or the header, trailer, or metadata thereof may be configured as an instruction to the client device to continue to request the second version of the content asset until indicated differently by the server (e.g., via a header in a subsequent response from the server indicating a different version), even if the client-side adaptive bitrate algorithm determines that the client device and network bandwidth are capable of a higher bitrate. That is, all subsequent requests by the client device for a video stream of the content asset, until directed otherwise by the server, should be for segments of the second version of the content asset. This may reduce the number of requests by the client device to shift versions and/or bitrates.

In practice, the second request may not be the next request from the client device that directly follows the first request. There may be some delay or offset between the first request and the second request due to buffering, for example. Or the client device may have not yet received the response indicating the second version when the next request was generated and sent to the server.

As noted, the server may receive the second request from the client device for the second segment of the second version of the content asset associated with the second bitrate. Like with the first request, the server may assess streaming the content asset to the client device via the second version of the content asset. For example, based on one or more usage characteristic associated with the server, such as a capability of the server to provide content to connected client devices, and/or the one or more business logic rules relating to bitrate, the server may determine a third version of the content asset, associated with a third bitrate (and/or encoding algorithm), for the client device to use in requesting a video stream of the content asset, or the server may determine that the client device should continue to request the second version. The one or more usage characteristics associated with the server here may be the same as or different from those used to determine the second version.

At step 210, the server may send one or more segments (e.g., the requested second segment) of the second version of the content asset to the client device. For example, the server may generate and send, to the client device, a second response (e.g., an HTTP response) comprising one or more segments (e.g., the requested second segment) of the second version of the content asset. The second response may indicate (e.g., via header, trailer, or metadata) either a third version of the content asset or again the second version, as the case may be. The client device may receive the second response from the server, decode the second segment, and cause to output the decoded second segment for viewer consumption. The client device may send, to the server, a third request for a third segment of the second/third version of the content asset, however indicated in the header in the second response.

The server may determine, for all requests from the client device, whether the client device should use a new version of the content asset or maintain using the same version of the content asset. For example, all of the responses from the server to the client device may include a header indicating either a new version of the content asset or the same version of the content asset as previously. Or the server may determine, at pre-determined intervals, whether the client device should use a new version or maintain the same version. For example, the server may make this determination and configure the response with a header accordingly every Nth (e.g., every 5th) request from the client device. Additionally or alternatively, the intervals may be on a time basis (e.g., at every 10 second mark).

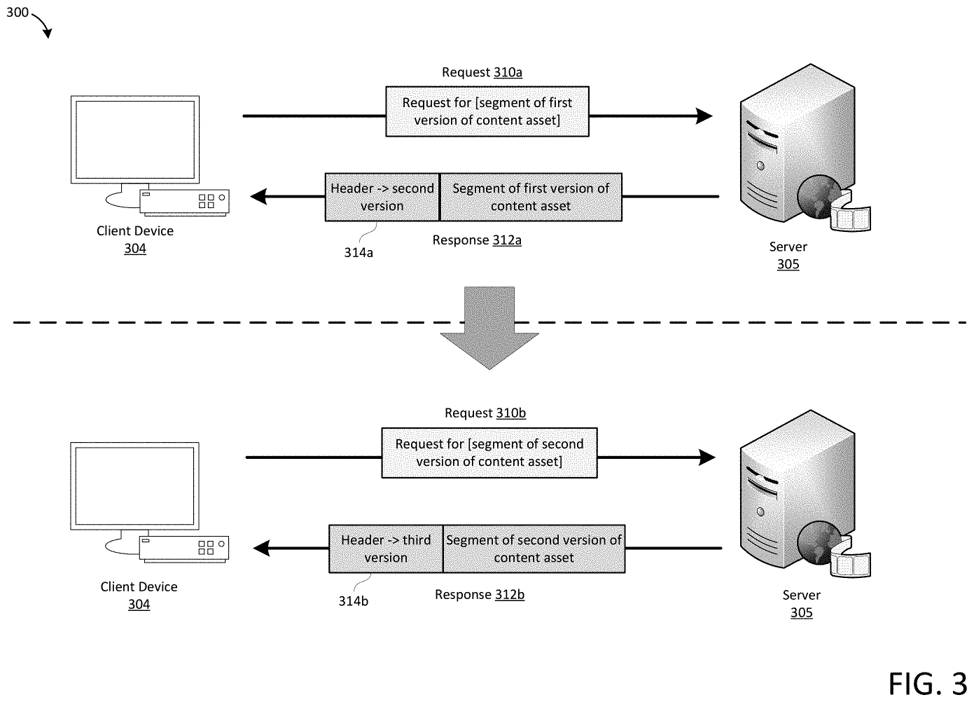

FIG. 3 shows a message flow diagram 300 relating to the techniques described in relation to the method 200 of FIG. 2. In the upper panel of the figure, a client device 304 (e.g., a client device 104 of FIG. 1) sends a first request 310a to a server 305 (e.g., the server 105 of FIG. 1). The first request 310a indicates a (first) segment of a first version of a content asset. For example, the first request 310a may comprise an HTTP request and the (first) segment of the first version of the content asset may be indicated in the HTTP request via a GET method. The server 305 receives the first request 310a. Based on one or more usage characteristics associated with the server 305 (e.g., one or more usage characteristics associated with a capability of the server 305 to provide content to connected client devices, such as server load) and/or any applicable business logic rules, the server 305 determines a second version of the content asset for the client to request in one or more subsequent requests to the server 305. The second version of the content asset may be associated with a lower bitrate than that associated with the first version of the content asset. For example, there may be contention among multiple client devices for the server's 305 resources and the lower bitrate may allow for more client devices to be concurrently connected to the server 305 without interruptions to their respective video streams.

The server 305 generates and sends a first response 312a to the client device 304. The first response 312a comprises a header 314a and the requested segment of the first version of the content asset. For example, the first response 312a may comprise an HTTP response and the header 314a may comprise an HTTP header. The header 314a indicates the second version of the content asset determined by the server 305 for use by the client device 304 in one or more subsequent requests for the content asset. The client device 304 receives the first response 312a and decodes the segment. The client device 304 may cause output of the decoded segment for viewer consumption.

Subsequently, in the lower panel, the client device 304 sends a second request 310b to the server 305. For example, the second request 310b may comprise an HTTP request. As directed to by the server 305 via the first response 312a, the second request 310b indicates a (second) segment of the second version of the content asset. For example, the second request 310b may indicate the (second) segment of the second version of the content asset via a GET method. The server 305 receives the second request 310b.

Like with the first request 310a, the server 305 determines a third version of the content asset based on one or more usage characteristics associated with the server (e.g., one or more usage characteristics associated with a capability of the server 305 to provide content to connected client devices, such as server load) and/or any applicable business logic rules. The third version may be associated with a higher bitrate, the same bitrate, or a lower bitrate than that of the second version of the content asset. For example, the load on the server 305 may have lessened (e.g., fallen below, or otherwise satisfied, a relevant threshold value) from when the second version was determined. In this case, the third version may be associated with a higher bitrate to allow for improved video quality when the server 305 is below capacity. The third version may be the same as the first version. Although not represented in FIG. 3, the server 305 may determine for the client device 304 to continue requesting segments of the second version of the content asset.

The server 305 generates a second response 312b with the requested segment of the second version of the content asset and sends it to the client device 304. The second response 312b may comprise an HTTP response, for example. The second response 312b further comprises a header 314b that indicates the third version of the content asset determined by the server 305. The header 314b may comprise an HTTP header, for example. The client device 304 may decode the segment of the second version from the second response 312b and cause output of the decoded segment. The client device 304 may send a request (e.g., an HTTP request) to the server 305 for a segment of the third version of the content asset, and so forth.

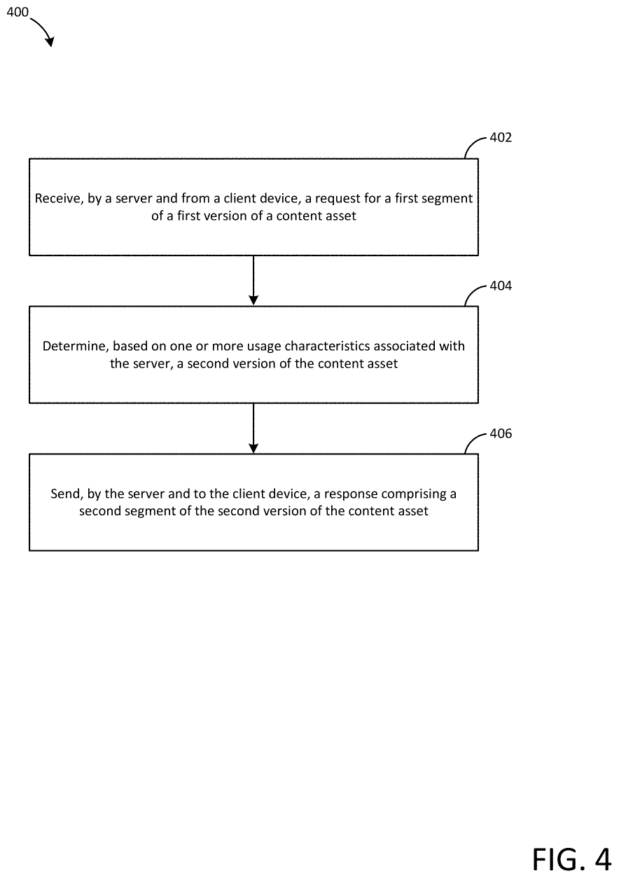

FIG. 4 shows a method 400. The method may relate to network control, such as video stream bitrate control. Such video streams may be configured for adaptive switching between various versions or representations of a content asset, i.e., adaptive bitrate streaming. The versions of a content asset may vary with respect to bitrate, for example. The versions of a content asset may additionally or alternatively vary according to compression technique, compression ratio, resolution, frame rate, video quality (for video), number of channels, or sampling rate (for audio).

At step 402, a server (e.g., the server 105 of FIG. 1) may receive a request (e.g., an HTTP request) from a client device (e.g., a client device 104 of FIG. 1) for a first segment of a first version, of a plurality of versions, of a content asset. The first version of the content asset may be associated with a first bitrate. Additionally or alternatively, the first version of the content asset may be associated with a first encoding algorithm. The first segment may comprise a video segment, for example. The client device may have requested the first segment of the first version based on a manifest associated with the content asset that was earlier provided to the client device by the server.

At step 404, a second version of the plurality of versions associated with the content asset may be determined based on one or more usage characteristics associated with the server. The one or more usage characteristics may be associated with a capability of the server to provide (e.g., send) content (e.g., content asset(s) or other data generally) to client devices connected to the server (e.g., those client devices sending requests to the server). For example, a usage characteristic associated with the server may comprise a load associated with the server, a hardware configuration of the server, and/or a software configuration of the server. The second version of the content asset may be additionally or alternatively determined based on one or more business logic rules. The second version may be determined by the server. The second version of the content asset may be the version that the server wants the client device to use in one or more subsequent requests for the video stream of the content asset. The second version of the content asset may additionally or alternatively be the version that the server wants to send to the client device at the server's next response to the client device. The second bitrate may be lower than the first bitrate, the same as the first bitrate, or higher than the first bitrate. The second version and/or second bitrate may be a single-step downshift or upshift, as the case may be, of the first version and/or first bitrate, respectively. Additionally or alternatively, the second version and the first version may refer to the same version of the content asset.

The second version of the content asset determined by the server may be associated with (e.g., encoded by) a second encoding algorithm. For example, the second encoding algorithm may be less computationally demanding than the first encoding algorithm associated with the first version of the content asset. The second encoding algorithm (if applicable) may or may not result in a bitrate that is different than the first bitrate associated with the first version of the content asset.

At step 406, the server may send, to the client device, a response (e.g., in response to the initial request from the client device) comprising a second segment of the determined second version of the content asset. The response may comprise a payload or body with the second segment of the second version. The response may comprise an HTTP response. The response may additionally or alternatively indicate the second version of the content asset, which the client device may use in requesting subsequent segments of the second version of the content asset. The response may indicate the second version in a header of the response, a trailer of the response, or metadata associated with the response. The client device may decode the segment and cause to output (e.g., display) the decoded segment for viewer consumption as part of the video stream.

The sending the response to the client device may be based on a capability of the server to provide (e.g., send) the first version of the content asset, e.g., the capability of the server to provide the first version of the content asset to the client device in particular and/or client devices generally. For example, high CPU or memory load on the server may negatively impact the capability of the server to provide the first version of the content asset. The sending the response to the client device may be additionally or alternatively based on a capability of the server to provide the content asset, regardless of the version of the content asset.

Additionally or alternatively, the server may receive a subsequent second request (e.g., an HTTP request) from the client device. The second request may indicate a second segment of the second version of the content asset. The second request may be determined by the client device based on the response from the server. The second request may be determined by the client device based on the second segment of the content asset stored or contained in the response. The second request may be determined by the client device based on the indication in the response (e.g., via a header, trailer, or metadata associated with the response) of the second version of the content asset. The second request may be additionally or alternatively based on the client-side adaptive bitrate algorithm, which may determine that the client device and network bandwidth are capable of sustaining a video stream of the second version associated with the second bitrate. The client device may continue to request segments of the second version of the content asset until indicated otherwise by the server (e.g., via a response sent from the server to the client device), even if, for example, the client-side adaptive bitrate algorithm determines that the client device and network bandwidth are capable of a higher bitrate.

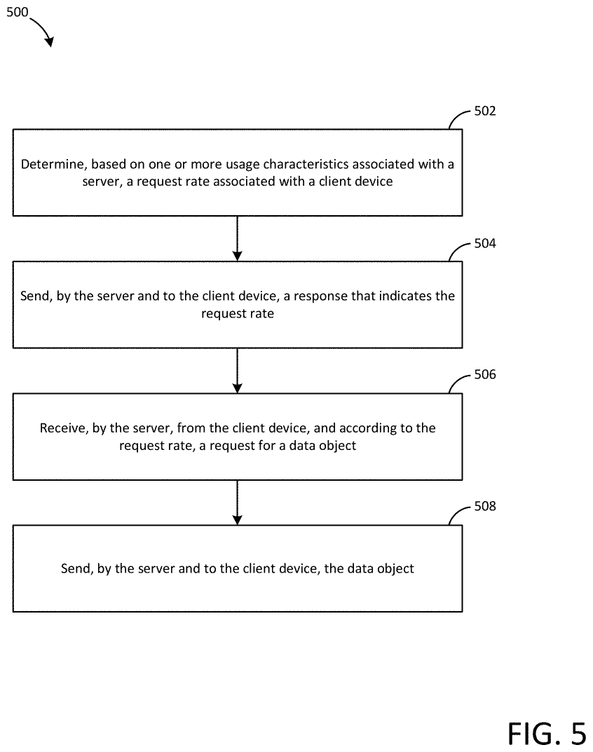

FIG. 5 shows a method 500. The method 500 may relate to network control, such as request rate (pacing) flow control. Such network control techniques may be applied to video streaming, including adaptive bitrate video streaming. For example, such video streaming may be implemented via HTTP. Additionally or alternatively, these network control techniques may be applied more generally to any client/server system, particularly where a client device makes regular application layer requests to a server for data.

At step 502, a first request rate associated with a client device (e.g., a client device 104 of FIG. 1) may be determined. The first request rate may be determined by a server (e.g., the server 105 of FIG. 1). The server may be configured to receive requests from the client device and respond, in turn, with a requested data object. The first request rate may be determined based on one or more usage characteristics associated with the server. The one or more usage characteristics may be associated with a capability of the server to provide (e.g., send) data (e.g., video and/or audio content) to client devices connected to the server (e.g., those client devices sending requests to the server). For example, such capability may refer to a capability of the server to respond to requests from client devices generally. Additionally or alternatively, for example, such capability may refer to a capability of the server to provide data to requesting client devices according to present request rates. A request rate may refer generally to a number of requests per second (or other time unit, such as requests per minute). A request rate may be additionally or alternatively expressed as the number of requests in the last n seconds (or other time unit), the number of requests in a current time period, or according to a “leaky bucket” metering algorithm.

The first request rate may be determined based on (e.g., responsive to) an earlier request, received by the server from the client device, for a data object. The earlier request may comprise an HTTP request. The earlier request may be received according to an earlier (second) request rate associated with the client device. That is, the client device may send the earlier request to the server according to the earlier (second) request rate. The earlier (second) request rate may have been already set or established (e.g., via the instant network control method) at the time the server receives the earlier request or the earlier (second) request rate may refer to an empirical request rate (e.g., average request rate) of the client device during an instant communication session with the server.

The data object indicated in the earlier request may comprise a first segment of a first version (e.g., video stream), of a plurality of versions, of a content asset. The first version of the content asset may be associated with a first bitrate and one or more other available versions of the content asset may be associated with different bitrates. Additionally or alternatively, the first version of the content asset may be associated with a first encoding algorithm and one or more other available versions of the content asset may be associated with different encoding algorithms. It is noted that the method 500 is applicable in contexts other than video streaming and the data object may comprise any form of data. The data object may be indicated in the earlier request via a GET, POST or other suitable HTTP method. The GET, POST, or other HTTP method may specify a location (e.g., a URI, such as a URL) of the data object at the server or associated storage.

As noted, the first request rate may be determined by the server and may be based on one or more usage characteristics associated with the server, such as a capability of the server to provide data to connected client devices. The one or more usage characteristics may comprise, for example, a load associated with the server. The load may be based on the server's CPU usage, GPU usage, memory usage, storage usage, available network resources, cryptographic offload hardware utilization, thermal dissipation capacity, electrical usage, financial utilization of hardware, or any combination thereof. The load may be based on the number of client devices with an active connection to the server. The load may be based on the number of requests being received by the server and/or the rate of such requests. For example, the load may be based on the request rate associated with the other client devices connected to the server. The request rate associated with the other client devices may be set or maintained via the instant network control method. The load associated with the server may be additionally or alternatively based on the performance of any applications running on the server (e.g., a software-level web server) that are associated with the data object. Determining the second request rate may comprise determining that the transmissions of the first data object and other similar data objects to the client device at the first request rate are (or will be) application limited or, conversely, determining that such transmissions are not (or will not be) application limited.

The one or more usage characteristics of the server may additionally or alternatively include the hardware and/or software configuration of the server, such as the server's processor(s), memory, storage, network interface(s), or other component of the server that may affect the server's performance. The one or more usage characteristics may include an indication that a characteristic, attribute, value, etc. associated with the server load or hardware/software configuration satisfies a threshold (e.g., is greater than, equal to, or less than, as the case may be). For example, determining the first request rate may comprise determining that the one or more usage characteristics (e.g., associated with a capability of the server to provide data to client devices) satisfies a threshold. For example, the first request rate may be determined based on the server's current CPU usage exceeding a threshold value. As another example, the first request rate may be determined based on an instant or earlier request rate associated with the client device exceeding a threshold request rate.

The first request rate may be determined according to a fair scheduling model in which the request rates for all of the client devices connected to the server are adjusted upwards or downwards in lockstep such that all the client devices are given an equal request rate by the server. For example, the server's capacity to respond to data requests may be allocated equally across the client devices connected to the server. If the server load increases or another client device connects to the server, the request rates for the client devices may be adjusted accordingly to maintain equal request rates cross all of the client devices. The server may indicate a determined request rate to other client devices connected to the server in a similar manner as for the instant client device (e.g., via a header of respective responses sent to the client devices by the server).

Additionally or alternatively, the first request rate may be determined according to a weighted model in which certain client devices are weighted relative to other client device according to one or more business logic rules. The business logic rules may be applied only when there is contention between client devices for the server's resource (e.g., the server is unable to timely respond to all data requests) and the above fair scheduling model may be applied at all other times. In some cases, the business logic rules may be applied at all times, regardless of contention.

A weighted (e.g., favored) client device may be given a request rate by the server that is greater than that of a non-weighted client device. Client device weighting may be performed on a per-client device basis, a per-subnet (of client devices) basis, or a per-user agent basis. The weighting may be based on any information derived from the request. For example, all client devices of a particular subnet may be weighted, such as networked devices in one region of the country receiving a greater share of server resources than networked devices in another region of the country. A client device may be weighted based on the identity of the client device. A user agent may refer to a software client, platform, or operating system executing on the client device that is configured to exchange and process request/response messages with the server. For example, server resources may be preferentially allocated to “first-screen” devices, such as televisions, over “second-screen” devices, such as mobile phones. Or a user agent running on a device may indicate to an operator that the device is an older-model device that is less fault-tolerant and so should receive a greater share of server resources to optimize customer satisfaction. Weighting may also be based on the content of the data object being requested and/or the data object's source. For example, in the context of video streaming, some content assets may be favored over others. If a client device requests video segments of a favored content asset (e.g., associated with a favored television network, content provider, etc.), that client device may be given a greater request rate than another client device that is requesting video segments of an un-favored content asset. In this manner, application layer quality-of-service functionality may be provided for favored content assets. Additional bases for weighting may include a geographical location of the client device, a market associated with the client device, a past history of service interruptions associated with the client device, and a service tier associated with the client device (e.g., with respect to a service provider, such as a cable television or video streaming provider).

At step 504, the server may send, to the client device, a response (e.g., an HTTP response) that indicates the determined first request rate associated with the client device. The response may comprise a header, trailer, and/or metadata that indicates the first request rate. The response may comprise a requested-for data object, such as a data object requested in an earlier request from the client device received by the server. The client device may receive the response and process the data object according to its associated data type and use. For example, where the data object comprises the first segment of the first version of the content asset, the client device may decode the segment and cause output of the decoded segment for viewer consumption. The header may be in the form of “X-FC-Pacing-Rate [FPR]” or “FC-Pacing-Rate [FPR]”, where FPR represents the indicated request rate (e.g., pacing rate).

The first request rate associated with the client device may be considered a “preferred” or “requested” request rate. In this case, the client device may elect to conform to the first request rate in its subsequent requests to the server, or the client device may ignore the first request rate. Yet in other cases, the first request rate may be a mandatory request rate for the client device. For example, the client device (e.g., the relevant client software running on the client device) may be configured such that it must comply with the first request rate in one or more of its subsequent data object request(s) to the server.

At step 506, the server may receive a request for a data object (e.g., another data object) from the client device. The request may be sent from the client device to the server according to the first request rate associated with the client device. For example, if the first request rate is less than the earlier (second) request rate, the client device may implement an additional delay between receiving the response from the server and sending the request to the server. Conversely, if the first request rate is greater than the earlier (second) request rate, the client device may send the request to the server earlier that it would have under the earlier (second) request rate. In either case, the client device may send the request to the server such that the span of time between receiving the response from the server and sending the request complies, proportionally, with the first request rate. The client device may additionally or alternatively have the option to send requests to the server at a rate lower than the first request rate.

The data object indicated in this request may comprise a second segment of a second version of the aforementioned content asset. The second version of the content asset may be associated with a second bitrate that is different than the bitrate associated with the first version of the content asset. Additionally or alternatively, the second version of the content asset may be associated with a second encoding algorithm that is different than the encoding algorithm associated with the first version of the content asset. The second version of the content asset may be determined (e.g., by the client device) based on the first request rate.

Based on receiving the request for the data object, the server may again assess the current request rate associated with the client device. Based on the one or more usage characteristics associated with the server (e.g., one or more usage characteristics associated with a capability of the server to provide data to connected client devices, such as server load) and/or the one or more business logic rules for client device weighting, the server may determine another request rate associated with the client device or the server may determine that the current request rate be maintained. The one or more usage characteristics associated with the server and/or business logic rules used to determine a new request rate may be the same as or different than those used to determine the current request rate.

At step 508, the server may send the data object to the client device. For example, the server may generate and send a second response (e.g., an HTTP response) to the client device. The second response may comprise the data object and indicate (e.g., via header, trailer, or metadata) either the new request rate associated with the client device or again the current request rate associated with the client device, whichever the case may be. The second response may additionally or alternatively indicate for the client device to maintain the current request rate. The client device may receive the second response and process the data object indicated therein according to its associated data type and use. For example, where the data object is the second segment of the second version of the content asset, the client device may decode the second segment and cause output of the decoded segment for viewer consumption.

This process may be repeated in a similar manner for one or more subsequent requests from the client device for a third data object, a fourth data object, and so forth. For example, the server may assess the request rate associated with the client device (and modify, if so determined) for all requests for a data object (and/or all requests generally) that are received from the client device. As another example, the server may assess the request rate associated with the client device (and modify, if so determined) for all requests for a manifest that are received from the client device.

Additionally or alternatively, the server may assess the request rate associated with the client device (and modify, if so determined) at certain intervals. The intervals may be measured according to the number of requests received from the client device. For example, the server may assess the client device's request rate at every 5th request (or other Nth request) received from the client device. Additionally or alternatively, the intervals may be measured on a time basis. For example, the server may assess the client device's request rate every 10 seconds (or other time interval). Rather than applying separate time intervals for each client device connected to the server, the server may apply a universal time interval for all client devices connected to the server. For example, the server may assess all the client devices' respective request rates at the defined time intervals (e.g., every 10 seconds). The resultant request rate for each client device—whether it is a modified request rate, an un-modified request rate, or an initial request rate for newly-connected client devices—may be communicated to that client devices in the header of the next response sent to that client device. In this universal time interval example, a request received by the server from the client device may not necessarily trigger the server to assess the client device's request rate, but rather an expiration of the universal time interval may so-trigger the server. For example, the server may assess the request rate associated with a client device at the next request, after expiration of the universal time interval, received from the client device.

It is noted that an assessment of the client device's request rate does not need to be synchronous with an assessment of one or more usage characteristics of the server (e.g., a load associated with the server). For example, the one or more usage characteristics associated with the server may be assessed at regular time intervals and stored. A subsequent assessment of the client device's request rate may refer back to the stored one or more usage characteristics for the most recent time interval. For example, the determination of multiple consecutive request rates for the client device may be based on a single prior assessment of one or more usage characteristics associated with the server.

The method 500 may be applied to regulate the bitrate of the video streams requested by a client device in adaptive bitrate video streaming. For example, the server may signal for a client device to request segments (of a version of a content asset) at a specified segment size. That is, the segments requested for and received by a client device may be all of the same specified file size. For example, the server may signal for a client device to request segments at the specified file size via a separate second header (e.g. HTTP header) in a response (e.g., HTTP response) from the server to the client device. With this, the bitrate of the video stream (e.g., the bitrate associated with a version of a content asset) requested by the client device may be a function of the request rate specified by the server for the client device. For example, if the server determines, based on the one or more usage characteristics associated with the server and/or one or more business rules relating to request rate or bitrate, that the client device should or must downshift its current bitrate, the server may determine a request rate for the client device that is lower than the client device's current request rate. The lower request rate may be indicated in a header in a response (e.g., bearing a requested-for segment) to the client device from the server.

For example, a client device may initially request segments of a first version of a content asset associated with a bitrate of 4 Mbit/s and according to a request rate of 0.5 requests per second (req/s). To maintain playback of this 4 Mbit/s version of the content asset, the client device may request 8 Mbit (i.e., ˜1 MB) segments every 2 seconds. The server may later determine that the client device should or must reduce the bitrate of the version provided to the client device to 2 Mbit/s (e.g., the server may be overloaded) and may thus proportionally reduce the request rate of the client device from 0.5 req/s to 0.25 req/s. The server may indicate the 0.25 req/s to the client device in a response from the server to the client device. Given the new, lower 0.25 req/s request rate, the client device may expectedly (to maintain the 8 Mbit segment size) request segments of a second version of the content asset that is associated with a bitrate of 2 Mbit/s.

Additionally or alternatively, the client device may be configured to more directly implement any bitrate upshift or downshift determined by the server. For example, the client device may initially request segments of a first version of a content asset that is associated with a first bitrate. The client device may make these requests according to a first request rate. As above, the server may determine a second request rate that is lower than the first request rate. The client device may receive a response from the server that indicates the second request rate. The client device may determine a second version of the content asset to request based on the second request rate and the first request rate. For example, based on the difference between the first request rate and the second request rate, the client device may reduce the first bitrate by the same or similar proportions to determine the second bitrate. For instance, if the second request rate is half of the first request rate, the second bitrate may be likewise determined to be half of the first bitrate. The client device may select a version of the content asset (e.g., from those versions indicated in a manifest) that corresponds to the second bitrate and request, according to the second request rate, one or more segments of that version from the server.

A response from the server to the client device (e.g., comprising a requested-for data object or video segment) may additionally or alternatively indicate that the server will be entering a period of downtime (planned or unplanned) and an anticipated time for such downtime. The response may indicate the downtime via a header, trailer, or metadata associated with the response. For example, the response may comprise a downtime header having a parameter value that indicates a countdown (e.g., in seconds) until the server will be brought down. The downtime header may be in the form of “X-FC-Downtime [FDT]” or “FC-Downtime [FDT]”, where FDT represents the countdown value. The downtime header may provide notice to the client device to take steps to maintain a video stream (or other type of data object) currently being received from the server before the server is taken down. For example, the client device may switch to an alternate server before the countdown given in the downtime header(s) expires. The alternate server may be indicated in an alternate-server header (and/or trailer or metadata) of a response from the server. The alternate-server header may be in the form of “X-FC-Alternate [FALT]” or “FC-Alternate [FALT]” where FALT indicates the hostname or IP address of the alternate server.

After initially inserting a downtime header in a response to indicate to the client device that the server will be taken down, the server may “retract” this message by omitting the downtime header in a later response to the client device. The client device may wait until the countdown value in the downtime headers nears zero before switching to an alternate server so as to give maximum opportunity for the server to cancel the downtime. An empty or “0” countdown value in the downtime header may indicate that the server will be taken down imminently. Additionally or alternatively, the presence of an alternate-server header in a response, but without a downtime header, may likewise indicate an imminent downtime of the server.

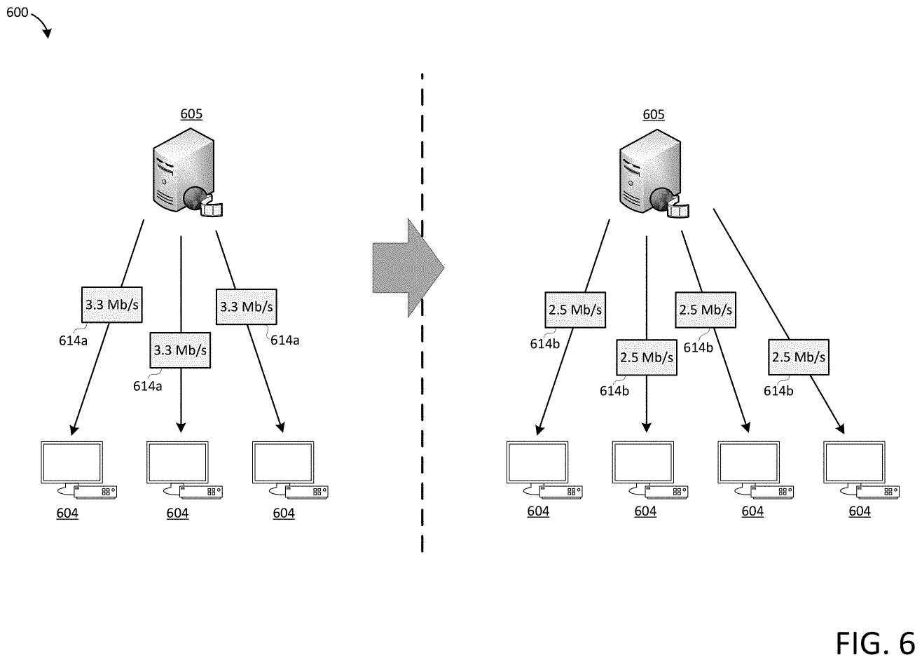

FIG. 6 shows a block diagram 600 relating to the network control techniques described herein. Although described primarily in terms of video bitrate (e.g., bitrates associated with respective versions of a content asset), FIG. 6 may apply equally to request rates and/or other types of data in addition to video data. The block diagram 600 may provide an example of a fair scheduling approach to network control. Such a fair scheduling approach may be implemented by a server 605 (e.g., the server 105 of FIG. 1), which is understood to have an example bitrate transmission capacity of 10 Mb/s. In practice, this figure is likely to be many times higher. Likewise, the number of client devices 604 connected to and/or making requests to the server is likely to be many times higher in practice.

In the left panel of the figure, three client devices 604 (e.g., the client devices 104 of FIG. 1) are connected to the server 605. For example, the client devices 604 may have each established a TCP session with the server 605 and a video stream may be provided to each of the client devices 604 from the server 605 via a series of requests from a client device 604 and corresponding responses, with the requested-for segments, from the server 605. The various requests from the client devices 604 are omitted from FIG. 6 for clarity of illustration. FIG. 6 does show a set of responses 614a from the server 605 to the respective client devices 604. Each of the responses 614a is configured with a header that indicates a bitrate of 3.3 Mb/s. For example, each of the responses 614 may indicate a particular version of a content asset associated with 3.3 Mb/s bitrate. Here, the bitrates for the client devices 604 are based, at least in part, on an equal division (rounded down) between the client devices 604 of the server's 605 example 10 Mb/s bitrate capacity.

In the right panel, which may represent a later time than in the left panel, four client devices 604 are connected to the server 605. For example, a fourth client device 604 may have joined the three client devices 604 shown in the left panel. If the 3.3 Mb/s bitrates were maintained from the first panel (e.g., the client devices 604 continued to request for and receive video content associated with those bitrates), the server 605 may be overloaded and unable to make timely responses to the various requests from the client devices 604. The server 605 may again apply a fair scheduling approach and indicate an equal 2.5 Mb/s bitrate to each of the four client devices 604 via headers in respective responses 614b sent to the client devices 604.

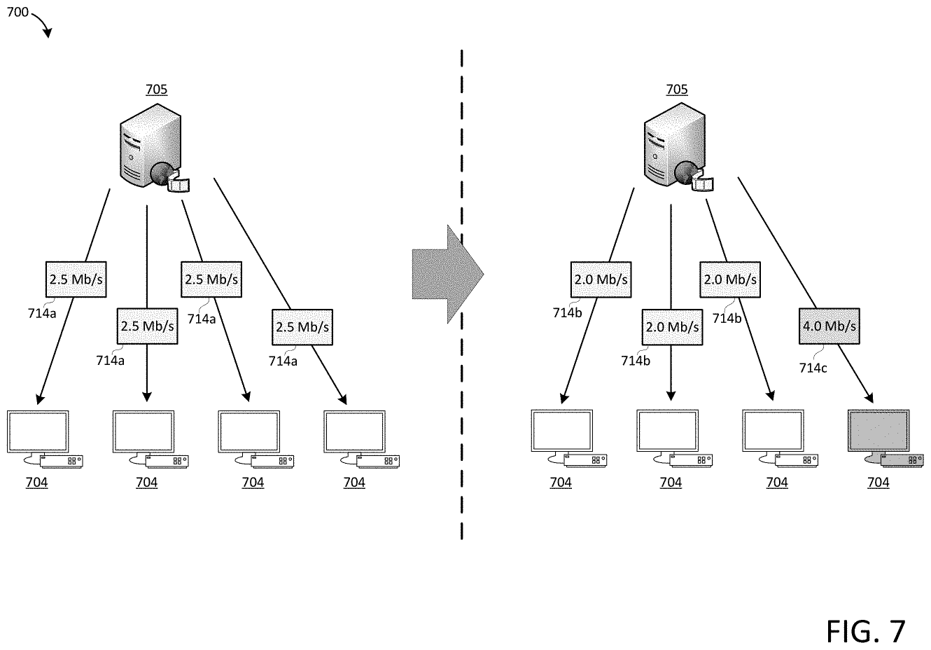

FIG. 7 shows a block diagram 700 relating to the network control techniques described herein. Although described primarily in terms of video bitrate (e.g., bitrates associated with respective versions of a content asset), FIG. 7 may apply equally to request rates and/or other types of data in addition to video data. The block diagram 700 may provide an example of a weighted approach to network control that is based on one or more business logic rules. Such a weighted scheduling approach may be implemented by a server 705 (e.g., the server 105 of FIG. 1), which is understood to have an example bitrate transmission capacity of 10 Mb/s.

In the left panel, four client devices 704 (e.g., the client devices 104 of FIG. 1) are connected to the server 705. For example, the client devices 704 may have each established a TCP session with the server 705 and a video stream may be provided to each of the client devices 704 from the server 705 via a series of request/response exchanges between the server 705 and the client devices 704. The various requests from the client devices 704 are omitted from FIG. 7 for clarity of illustration. Like in the left or right panel in FIG. 6, the server 705 in this left panel applies a fair scheduling approach and indicates an equal 2.5 Mb/s bitrate to each client device 704 via a header in respective HTTP responses 714a sent from the server 705 to the client devices 704. For example, a header in an HTTP response 714a may indicate a version of a content asset associated with a 2.5 Mb/s bitrate.

In the right panel of FIG. 7, the server 705 applies a weighted approach to network control for the four client devices 704. The right panel may represent a later time than that represented in the left panel. The four client devices 704 in the right panel may be the same as those in the left panel or different, at least in part, from those in the left panel. Here, the server 705 determines a disproportionate bitrate of 4.0 Mb/s for the right-most shaded client device 704 and indicates as such in a header of a response 714c sent from the server 705 to the shaded client device 704. The responses 714b for the other three client devices 704 indicate equal bitrates of 2.0 Mb/s.

The server 705 may have determined the disproportionate 4.0 Mb/s bitrate for the shaded client device 704 based on one or more business logic rules, which may take into account a client device itself (e.g., a client device is identified as a favored client device), a video stream (or other data object) that is being provided to a client device, a subnet in which a client device is a part, or a user-agent of a client device. For example, the shaded client device 704 in the right panel may be streaming a video stream that comprises favored content (e.g., content associated with a favored television network, favored content provider, etc.). Assuming that the shaded client device 704 was also one of the client devices 704 in the left panel, the shaded client device 704 may not have been given a disproportionate request rate at the time of the left panel because the shaded client device 704 might not have been streaming the video stream comprising the favored content at that time.

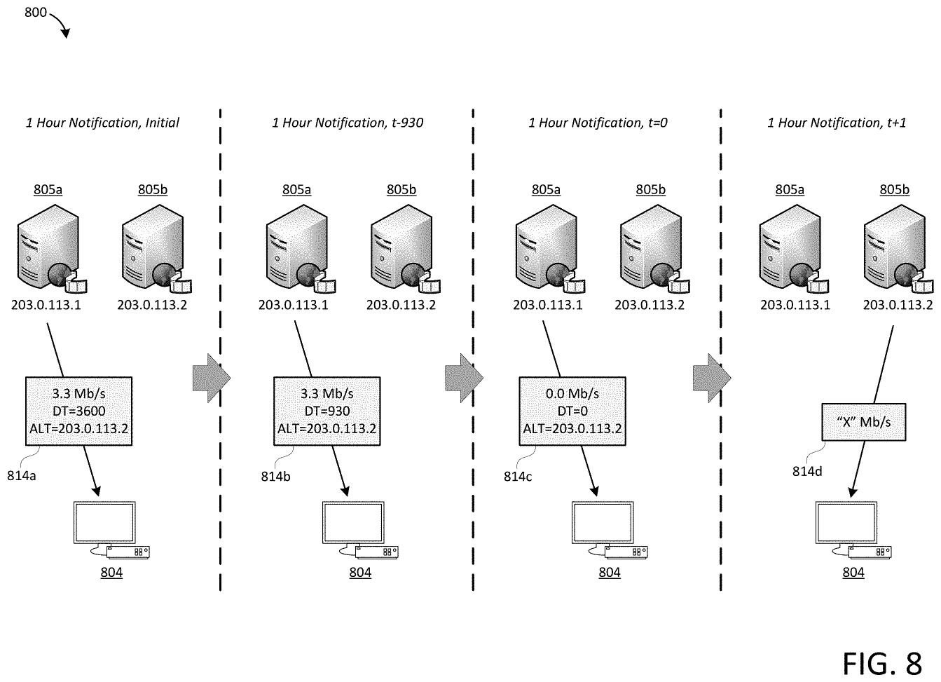

FIG. 8 shows a block diagram 800 relating to the network control techniques described herein. The block diagram 800 may provide an example of network control that may be performed in advance of a server shutdown. Such network control may minimize or even prevent any interruptions to a video stream that is initially provided by a server that is planned to be shutdown. Although described primarily in terms of video bitrate (e.g., bitrates associated with respective versions of a content asset), FIG. 8 may apply equally to request rates and/or other types of data in addition to video data. It will be further noted that the various requests and responses discussed in relation to FIG. 8 do not necessarily have to indicate a bitrate (or request rate). Nor is it necessarily required that such requests and responses accord to any specified bitrate (or request rate).

The block diagram 800 is organized as a series of four panels in which time advances from left to right. Each panel includes a first server 805a and a second server 805b, each of which may be the same as or similar to the server 105 in FIG. 1. The second server 805b may be designated as an alternate server for the first server 805a. For example, the first server 805a and the second server 805b may be server mirrors. The first server 805a has an IP address of 203.0.113.1 and the second server 805b has an IP address of 203.0.113.2. Each panel further includes a client device 804 (e.g., a client device 104 of FIG. 1) that is configured to communicate with at least one of the first server 805a or the second server 805b. For example, the client device 804 may request for and receive a video stream from at least one of the first server 805a or the second server 805b via a series of request/response exchanges with the first server 805a or the second server 805b, as the case may be.

In the (first) left-most panel, labeled with respect to time as “1 Hour Notification, Initial,” the client device 804 receives a response 814a (e.g., an HTTP response) from the first server 805a that comprises a bitrate header, a downtime header, and an alternate-server header. The bitrate header indicates a bitrate for the client device 804 of 3.3 Mb/s. The bitrate header may additionally or alternatively indicate a version (e.g., video stream) of a content asset associated with a 3.3 Mb/s bitrate. The downtime header indicates a downtime countdown of 3600 seconds (“DT=3600”), or one hour. The alternate-server header indicates an IP address for an alternate sever of 203.0.113.2 (“ALT=203.0.113.2”), which is the IP address of the second server 805b. Because the downtime header indicates that the first server 805a is not going to be shut down until an hour later, the client device 804 may continue to request for and receive the video stream from the first server 805a according to the 3.3 Mb/s bitrate.

The response 814a may be based on a request for a video segment that was received by the first server 805a from the client device 804. The first server 805a may determine its anticipated shutdown and the time for the anticipated shutdown (e.g., the 3600 second countdown). The shutdown time may be additionally or alternatively represented in other forms, such as a clock time. The 3.3 Mb/s bitrate may have been determined based on a load or other usage characteristic(s) associated with the first server 805a.

In the next (second) panel to the right, labeled with respect to time as “1 Hour Notification, t−930,” the client device 804 receives a response 814b from the first server 805a that comprises a bitrate header, a downtime header, and an alternate-server header. The response 814b may be based on an request for a video segment of a video stream associated with a 3.3 Mb/s bitrate. The bitrate header continues to indicate a bitrate of 3.3 Mb/s (e.g., a version of a content asset associated with a 3.3 Mb/s bitrate). The downtime header indicates a downtime countdown of 930 seconds (“DT=930”), or 15 minutes and 30 seconds. The alternate-server header again indicates the second server 805b as the alternate server (“ALT=203.0.113.2”). The client device 804 may continue to request for and receive the video stream from the first server 805a since more than 15 minutes still remains until the first server 805a is expected to be shutdown.

In the next (third) panel to the right, labeled with respect to time as “1 Hour Notification, t=0,” the client device 804 receives a response 814c from the first server 805a that comprises a bitrate header, a downtime header, and an alternate-server header. The bitrate header indicates a bitrate for the client device 804 of 0.0 Mb/s. This alone may indicate to the client device 804 that the client device 804 should discontinue requests to the first server 805a. Additionally or alternatively, the response 814c may omit a bitrate header to signal that no versions (e.g., video streams) of the content asset will be available from the first server 805a. The downtime header indicates a downtime countdown of 0 seconds (“DT=0”), meaning that shutdown of the first server 805a is imminent. The alternate-server header again indicates the second server 805b as the alternate server (“ALT=203.0.113.2”).

In the next (fourth) right-most panel, labeled with respect to time as “1 Hour Notification, t+1,” the client device 804 is connected to the second server 805b according to the alternate-server headers in the previous responses 814a,b,c from the first server 805a. The client device 804 may request for and receive a continuation of the video stream initially provided by the first server 805a. The client device 804 may receive the video stream from the second server 804b via a series of request/response exchanges with the second server 805b. The second server 805b may determine a bitrate for the client device 804 according to the techniques described herein. The determined bitrate rate is indicated in a response 814d (“X′ Mb/s”) to the client device 804.

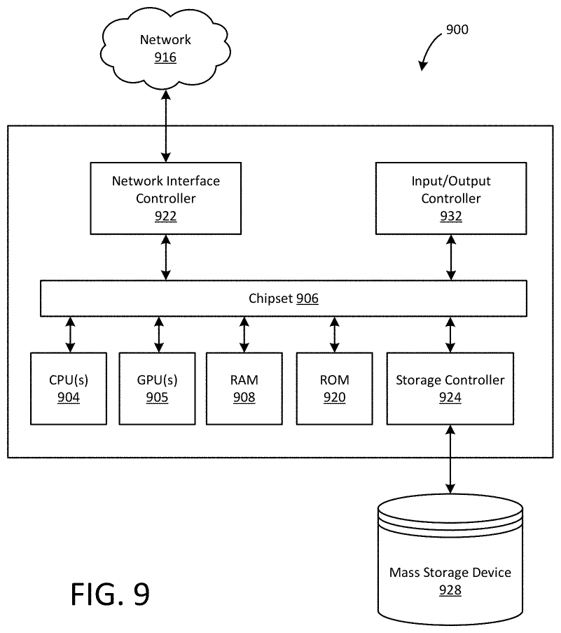

FIG. 9 shows an example computing device in which the systems, methods, and devices disclosed herein, or all or some aspects thereof, may be embodied. For example, components such as the video distribution system 102, the video source 103, the server 105, or the client devices 104 of FIG. 1 may be implemented generally in a computing device, such as the computing device 900 of FIG. 9. The computing device of FIG. 9 may be all or part of a server, workstation, desktop computer, laptop, tablet, network appliance, PDA, e-reader, digital cellular phone, set top box, or the like, and may be utilized to implement any of the aspects of the systems, methods, and devices described herein.

The computing device 900 may include a baseboard, or “motherboard,” which is a printed circuit board to which a multitude of components or devices may be connected by way of a system bus or other electrical communication paths. One or more central processing units (CPUs) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 904 may be augmented with or replaced by other processing units, such as GPU(s) 905. The GPU(s) 905 may comprise processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random access memory (RAM) 908 used as the main memory in the computing device 900. The chipset 906 may further provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 900 in accordance with the aspects described herein.

The computing device 900 may operate in a networked environment using logical connections to remote computing nodes and computer systems through local area network (LAN) 916. The chipset 906 may include functionality for providing network connectivity through a network interface controller (NIC) 922, such as a gigabit Ethernet adapter. A NIC 922 may be capable of connecting the computing device 900 to other computing nodes over a network 916. It should be appreciated that multiple NICs 922 may be present in the computing device 900, connecting the computing device to other types of networks and remote computer systems.

The computing device 900 may be connected to a mass storage device 928 that provides non-volatile storage for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 928 is characterized as primary or secondary storage and the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may further read information from the mass storage device 928 by detecting the physical states or characteristics of one or more particular locations within the physical storage units.

In addition to the mass storage device 928 described above, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 928 depicted in FIG. 9, may store an operating system utilized to control the operation of the computing device 900. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described above. The computing device 900 may have access to computer-readable storage media storing computer-executable instructions, which, when executed by the computing device 900, may perform the methods described herein.

A computing device, such as the computing device 900 depicted in FIG. 9, may also include an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not include all of the components shown in FIG. 9, may include other components that are not explicitly shown in FIG. 9, or may utilize an architecture completely different than that shown in FIG. 9.

As described herein, a computing device may be a physical computing device, such as the computing device 900 of FIG. 9. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the systems, methods, and devices are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described systems, methods, and devices. When combinations, subsets, interactions, groups, etc., of these components are described, it is understood that while specific references to each of the various individual and collective combinations and permutations of these may not be explicitly described, each is specifically contemplated and described herein, for all systems, methods, and devices. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the systems, methods, and devices may take the form of an entirely hardware embodiment, an entirely software embodiment, or an embodiment combining software and hardware aspects. Furthermore, the systems, methods, and devices may take the form of a computer program product on a computer-readable storage medium having computer-readable program instructions (e.g., computer software) embodied in the storage medium. More particularly, the present systems, methods, and devices may take the form of web-implemented computer software. Any suitable computer-readable storage medium may be utilized including hard disks, CD-ROMs, optical storage devices, or magnetic storage devices.

Embodiments of the systems, methods, and devices are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the systems, methods, and devices have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a computing device and from a client device, a first request for a first segment of a first version, of a plurality of versions, of a content asset;
determining, based on one or more usage characteristics associated with a capability of the computing device to provide content to client devices connected to the computing device, a second version, of the plurality of versions, of the content asset;
sending, by the computing device and to the client device, a response that indicates the second version of the content asset;
receiving, by the computing device and from the client device, a second request for a second segment of the second version of the content asset; and
sending, by the computing device and to the client device, one or more segments of the second version of the content asset.

2. The method of claim 1, wherein the first version of the content asset is associated with a first bitrate and the second version of the content asset is associated with a second bitrate.

3. The method of claim 2, wherein the response comprises an instructions for the client device to at least one of: downshift the first version of the content asset associated with the first bitrate down to the second version of the content asset associated with the second bitrate, or upshift the first version of the content asset associated with the first bitrate up to the second version of the content asset associated with the second bitrate.

4. The method of claim 1, wherein the response further comprises the first segment of the first version of the content asset.

5. The method of claim 1, wherein the response indicates the second version of the content asset via at least one of a header associated with the response, a trailer associated with the response, or metadata associated with the response.

6. The method of claim 1, wherein the first version of the content asset is associated with a first encoding algorithm and the second version of the content asset is associated with a second encoding algorithm.

7. The method of claim 1, wherein the response comprises an instruction for the client device to request segments of the first version of the content asset for all subsequent segment requests associated with the content asset until a second response from the computing device indicates a third version, of the plurality of versions, of the content asset.

8. The method of claim 1, wherein the plurality of versions of the content asset comprise respective video streams of the content asset implemented according to adaptive bitrate streaming techniques.

9. The method of claim 1, wherein the one or more usage characteristics associated with the capability of the computing device to provide content to client devices connected to the computing device comprises at least one of: a number of concurrent client devices connected to the computing device, a rate of requests to the computing device, the computing device's CPU usage, the computing device's GPU usage, the computing device's memory usage, the computing device's storage usage, the computing device's network resource availability, the computing device's cryptographic offload hardware utilization, the computing device's thermal dissipation capacity, the computing device's electrical usage, a financial utilization of hardware associated with the computing device, a hardware configuration of the computing device, or a software configuration of the computing device.

10. The method of claim 1, wherein the first request comprises a first HTTP request for the first segment, the response comprises an HTTP response comprising an HTTP header that indicates the second version of the content asset, and the second request comprises a second HTTP request for the second segment.

11. A method comprising:
receiving, by a computing device and from a client device, a request for a first segment of a first version, of a plurality of versions, of a content asset;
determining, based on one or more usage characteristics associated with a capability of the computing device to provide content to client devices connected to the computing device, a second version, of the plurality of versions, of the content asset; and
sending, by the computing device and to the client device, a response comprising a segment of the second version of the content asset.

12. The method of claim 11, further comprising:
receiving, by the computing device and from the client device, a second request for a third segment of the second version of the content asset.

13. The method of claim 11, wherein the response indicates the second version of the content asset.

14. A method comprising:
determining, based on one or more usage characteristics associated with a capability of a computing device to provide data to client devices connected to the computing device, a request rate associated with a client device;
sending, by the computing device and to the client device, a response that indicates the request rate associated with the client device;
receiving, by the computing device, from the client device, and according to the request rate associated with the client device, a request for a data object; and
sending, by the computing device and to the client device, the data object.

15. The method of claim 14, wherein the response further comprises a second data object earlier requested by the client device.

16. The method of claim 14, further comprising:
receiving, by the computing device, from the client device, and according to a second request rate associated with the client device, a second request for a second data object, wherein the determining the request rate associated with the client device is based on the receiving the second request for the second data object.

17. The method of claim 16, wherein the second data object comprises a first segment of a first version, of a plurality of versions, of a content asset, and the data object comprises a second segment of a second version, of the plurality of versions, of the content asset.

18. The method of claim 17, wherein the response comprises an instruction for the client device to request the second segment of the second version of the content asset.

19. The method of claim 14, wherein the response indicates the request rate via at least one of a header associated with the response, a trailer associated with the response, or metadata associated with the response.

20. The method of claim 14, wherein the request rate is based on a fair scheduling model in which the request rate associated with the client device is equal to request rates associated with other client devices connected to the computing device.

21. The method of claim 14, wherein the request rate is based on a weighted model in which the request rate associated with the client device is different than a request rate associated with at least one other client device connected to the computing device.

22. The method of claim 21, wherein the request rate is further based on at least one of: an identity of the client device, a user agent executing on the client device that is configured to receive the response and send the request, a subnet associated with the client device, content of the data object, a source of the data object, a geographical location of the client device, a market associated with the client device, a past history of service interruptions associated with the client device, or a service tier associated with the client device.

23. The method of claim 14, wherein the response indicates an anticipated shutdown of the computing device.

24. The method of claim 23, wherein the response indicates the anticipated shutdown of the computing device via at least one of a header associated with the response, a trailer associated with the response, or metadata associated with the response.

25. The method of claim 14, wherein the response indicates an alternate computing device from which the client device may request a second data object associated with the data object.
